(19) United States
(12) Patent Application Publication
(10) Pub. No.: US 2014/0000267 A1
(43) Pub. Date: Jan. 2, 2014

(54) TRANSITION DUCT FOR A GAS TURBINE

(71) Applicant: Patrick Benedict Melton, Horse Shoe, NC (US)

(72) Inventor: Patrick Benedict Melton, Horse Shoe, NC (US)

(73) Assignee: GENERAL ELECTRIC COMPANY, Schenectady, NY (US)

(21) Appl. No.: 13/538,333

(22) Filed: Jun. 29, 2012

(51) Int. Cl. F02C 7/00

(52) U.S. Cl. 60/752

(57) ABSTRACT

A transition duct for a combustor of a gas turbine generally includes an end frame that has a radially outer portion, a radially inner portion opposed to the radially outer portion, a first side portion between the radially outer and inner portions, and a second side portion opposed to the first side portion between the radially outer and inner portions. A slot may be in at least one of the radially outer portion, radially inner portion, first side portion, or second side portion of the end frame. A first plurality of axially extending passages may pass through the end frame and intersect with the slot. A terminal end of the end frame may be uninterrupted adjacent to the slot.

### FIELD OF THE INVENTION

The present invention generally involves a transition duct for a gas turbine. In particular, the invention relates to a transition duct having an end frame disposed at a downstream end the transition duct.

### BACKGROUND OF THE INVENTION

A conventional gas turbine system includes a compressor, one or more combustors, and a turbine. In a conventional gas turbine system, compressed air is provided from the compressor to the one or more combustors. The air entering the one or more combustors is mixed with fuel and combusted. Hot gases of combustion flow from each of one or more combustors through a transition duct and into the turbine to drive the gas turbine system and generate power.

In certain combustor designs, an end frame may surround a downstream end of the transition duct. The end frame may generally include a terminal end generally adjacent to the turbine. As a result, the end frame terminal end may be exposed to extreme thermal stresses caused by the hot gases flowing from the transition duct into the turbine.

Various techniques for reducing the thermal stresses and to enhance the mechanical life of the end frame generally include milling cooling passages through the end frame terminal end so that a cooling medium such as the compress air from the compressor may flow through the passages to cool the end frame terminal end. There is a need for a transition duct that allows for cooling of at least a portion of the end frame terminal end by decreasing and/or eliminating the cooling passages that extend through the end frame terminal end would be useful.

### BRIEF DESCRIPTION OF THE INVENTION

Aspects and advantages of the invention are set forth below in the following description, or may be obvious from the description, or may be learned through practice of the invention.

One embodiment of the present invention is a transition duct having an end frame. The end frame may include a radially outer portion, a radially inner portion opposed to the radially outer portion, a first side portion between the radially outer and inner portions, and a second side portion opposed to the first side portion between the radially outer and inner portions, and a slot in at least one of the radially outer portion, radially inner portion, first side, or second side of the end frame. A first plurality of axially extending passages extends through the end frame and may intersect with the slot. A terminal end of the end frame may be generally continuous adjacent to the slot.

Another embodiment of the present invention is a transition duct that generally includes an end frame that has a radially outer portion, a radially inner portion opposed to the radially outer portion, a first side portion between the radially outer and inner portions, and a second side portion opposed to the first side portion between the radially outer and inner portions. The end frame may also include a radial passage in at least one of the radially outer portion, the radially inner portion, the first side portion, or the second side portion of the end frame. A first plurality of axial passages extends through the end frame and terminates at the radial passage. A terminal end of the end frame may be generally downstream from the radial passage, and a continuous layer of heat resistant material may be disposed on the terminal end adjacent to the radial passage.

The present invention may also include a transition duct that generally includes an end frame having a radially outer portion, a radially inner portion opposed to the radially outer portion, a first side portion between the radially outer and inner portions, and a second side portion opposed to the first side portion between the radially outer and inner portion, and a terminal end of the end frame. The transition duct also includes means for cooling the end frame terminal end.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 illustrates a partial cross section of an exemplary gas turbine;

FIG. 2 illustrates a side view of a cross section of an exemplary combustor as shown in FIG. 1;

FIG. 3 illustrates a plan view of an exemplary transition duct as shown in FIG. 2, according to at least one embodiment of the present disclosure;

FIG. 4 illustrates a top view of a cross section of a portion of the transition duct taken at line A-A as shown in FIG. 3, according to at least one embodiment of the present disclosure;

FIG. 5 illustrates a side view of a cross section taken at line B-B of a portion of the transition duct as shown in FIG. 3, according to at least one embodiment of the present disclosure;

FIG. 6 illustrates a side view of a cross section taken at line B-B of a portion of the transition duct as shown in FIG. 3, according to at least one embodiment of the present disclosure;

FIG. 7 illustrates a side view of a portion of the transition duct as shown in FIG. 3, according to at least one embodiment of the present disclosure;

FIG. 8 illustrates a top view of a cross section of a portion of the transition duct taken at line A-A as shown in FIG. 3, according to at least one embodiment of the present disclosure;

FIG. 9 illustrates a side view of a portion of the cross section taken at line B-B as shown in FIG. 3, according to at least one embodiment of the present disclosure; and

FIG. 10 illustrates a side view of a portion of the cross section taken at line B-B as shown in FIG. 3, according to at least one embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a transition duct for a combustor of a gas turbine. The transition duct generally includes an end frame that surrounds a downstream end of the transition duct. The end frame includes a terminal end generally disposed adjacent to a turbine section of the gas turbine. In particular embodiments, the end frame may include one or more slots. The one or more slots may include an upstream surface axially separated from a downstream surface where the one or more slots downstream surface is generally adjacent to the end frame terminal end. The end frame may also include a plurality of axially extending passages that extend through a portion of the end frame and intersect with the one or more slots. In this manner, a compressed working fluid may flow through at least a portion of the plurality of axially extending passages and into the one or more slots, thereby impinging the compressed working fluid on and/or flowing the compressed working fluid across the one or more slots downstream surface adjacent the end frame terminal end. The volume between the slot downstream surface and the end frame terminal end may form an integral heat shield between the end frame and the turbine section. As a result, the compressed working fluid may cool the end frame terminal end, thus resulting in reduced thermal stresses on the end frame and improved mechanical life of the end frame and the transition duct.

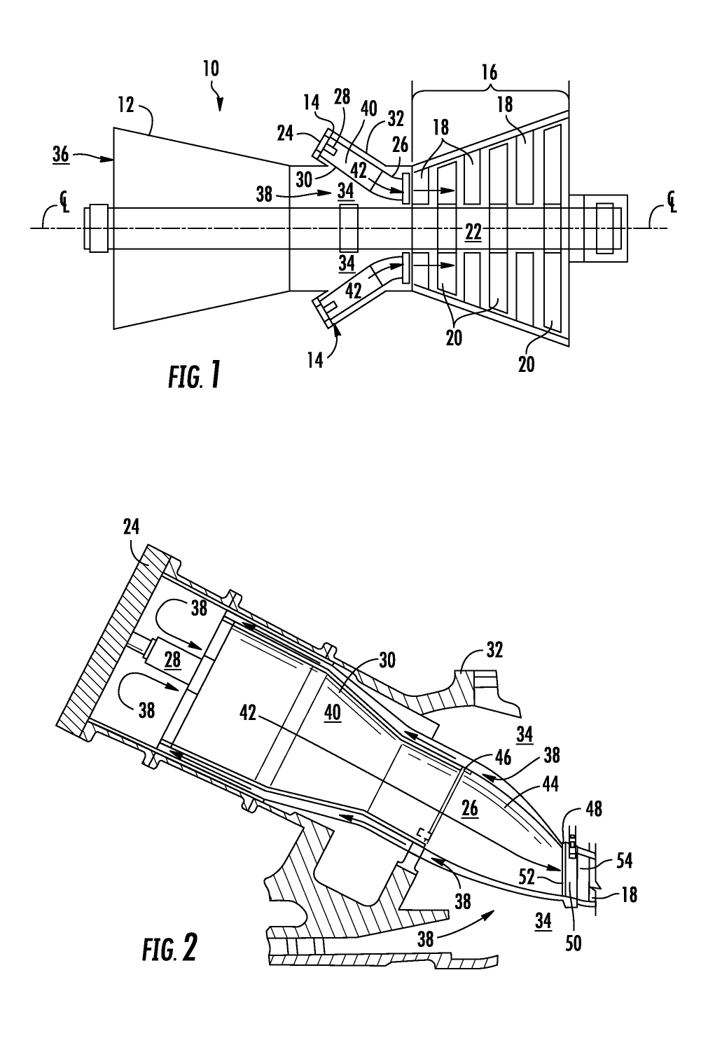

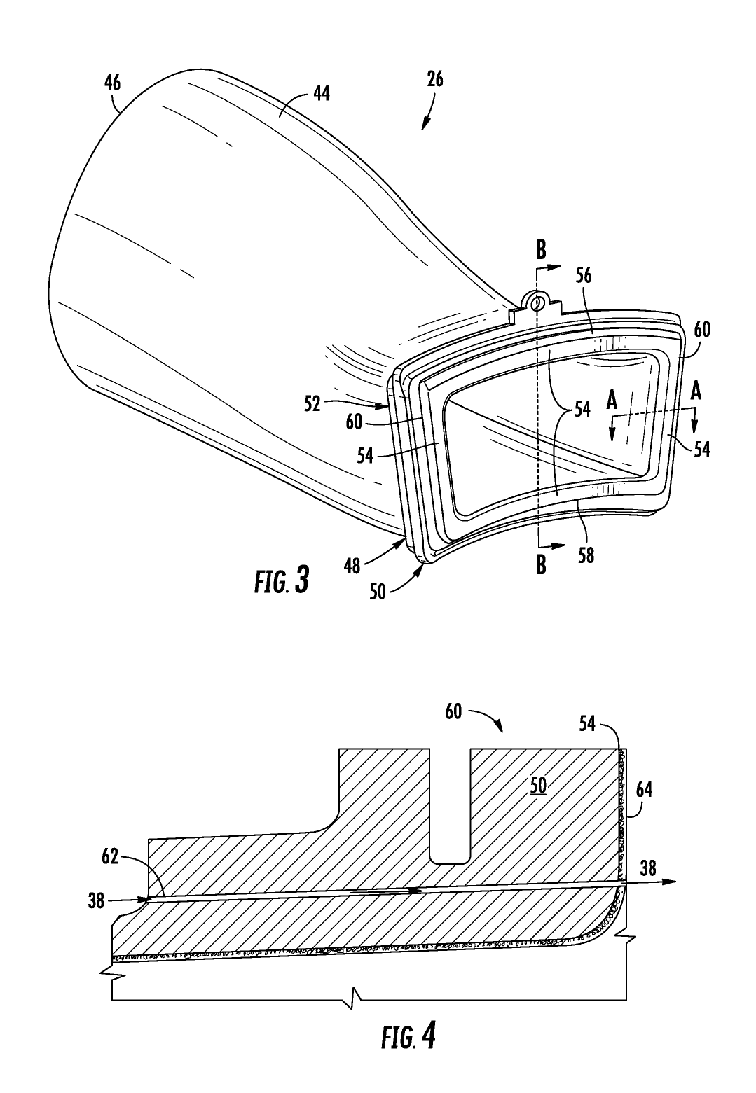

FIG. 1 illustrates an exemplary gas turbine and a cross section of a portion of the gas turbine, FIG. 2 illustrates a cross sectional view of a combustor of the gas turbine as shown in FIG. 1. As shown in FIG. 1, a gas turbine 10 generally includes a compressor 12, one or more combustors 14 downstream from the compressor 12 and a turbine section 16 downstream from the plurality of combustors 14. As shown, the plurality of combustors 14 may be arranged in an annular array about an axial centerline of the gas turbine 10. The turbine section 16 may generally include alternating stages of stationary vanes 18 and rotating blades 20. The rotating blades 20 may be coupled to a shaft 22 that extends through the turbine section 16. As shown in FIG. 2, each of the plurality of combustors 14 may include an end cover 24 at one end and a transition duct 26 at the other end. One or more fuel nozzles 28 may extend generally downstream from the end cover 24. A combustion liner 30 may at least partially surround and extend downstream from the one or more fuel nozzles 28. The transition duct 26 may extend downstream from the combustion liner 30 and may terminate adjacent to a first stage of the stationary vanes 18. In alternate designs, the transition duct 26 may extend downstream from the one or more fuel nozzles 28. As shown in FIGS. 1 and 2, a casing 32 may generally surround the one or more combustors 14 so as to form a plenum 34. The plenum 34 at least partially surrounds the combustion liner 30 and/or the transition duct 26.

In operation, as shown in FIG. 1, a working fluid 36 such as ambient air enters the compressor 12 and flows through the compressor 12 into the plenum 34 as a compressed working fluid 38. As shown in FIG. 2, a portion of the compressed working fluid 38 may flow across the transition duct 26 and towards the end cover 24 before reversing direction. The compressed working fluid 38 mixes with fuel from the one or more fuel nozzles 28 so as to form a combustible mixture within a combustion chamber 40 that may be at least partially defined inside the combustion liner 30. The combustible mixture is burned to produce a rapidly expanding hot gas 42. The hot gas 42 generally flows from the combustion liner 30, if present, through the transition duct 26 and into the turbine section 16 where energy from the hot gas 42 is transferred to the various stages of rotating blades 20 attached to the shaft 22, thereby causing the shaft 22 to rotate and produce mechanical work. The mechanical work produced may drive the compressor 12 or other external loads, such as a generator (not shown) to produce electricity. Another portion of the compressed working fluid 38 from the plenum 34 may be utilized primarily for cooling various components within the plurality of the combustors 14 and/or the turbine section 16.

FIG. 3 provides a plan view of an exemplary transition duct 26 as shown in FIG. 2, according to at least one embodiment of the present disclosure. As shown in FIGS. 2 and 3, the transition duct 26 generally includes a tubular body 44 having a forward end 46 and an aft end 48 downstream from the forward end 46. The forward end 46 may be generally annular and may be configured to engage with the combustion liner 30. In particular embodiments, the transition duct 26 may include an end frame 50 that at least partially circumferentially surrounds the aft end 48 of the tubular body 44. In certain embodiments, the end frame 50 may be cast and/or machined as an integral part of the tubular body 44 aft end 48. In other embodiments, the end frame 50 may be a separate component connected to the tubular body 44 aft end 48. For example, but not limiting of, the end frame 50 may be connected to the aft end 48 by welding.

As shown in FIGS. 2 and 3, the end frame 50 generally includes an upstream end 52, and a terminal end 54 axially separated from the upstream end. As shown in FIG. 2, the terminal end 54 of the end frame 50 may be disposed generally adjacent to the first stage of the stationary vanes 18 of the turbine section 16. As shown in FIG. 3, the terminal end 54 of the end frame 50 may be generally flat. In particular embodiments, at least a portion of the terminal end may be continuous. As used herein, the term “continuous” means a solid uninterrupted surface generally devoid of through holes or through passages.

As shown in FIG. 3, the end frame 50 may generally include a radially outer portion 56 disposed radially outward from the axial centerline of the end frame 50, and a radially inner portion 58 disposed radially inward from the radially outer portion 56. The end frame 50 may further include a pair of side portions 60. Each of the pair of side portions 60 extend generally radially between the radially outer portion 56 and radially inner portion 58. In particular embodiments, the radially inner portion 58, the radially outer portion 56, and the pair of side portions 60 may be generally adjacent to the end frame 50 terminal end 54.

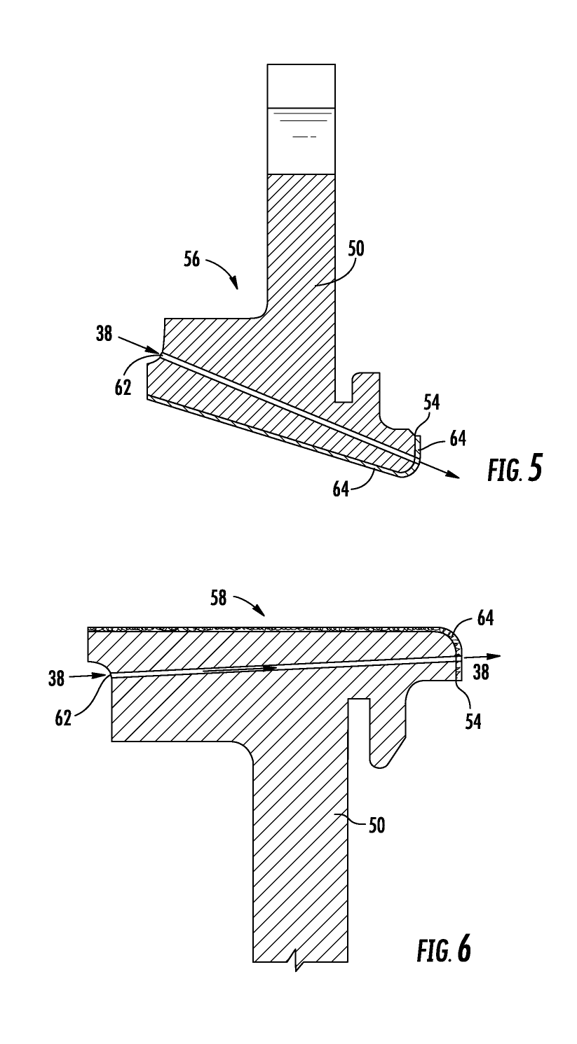

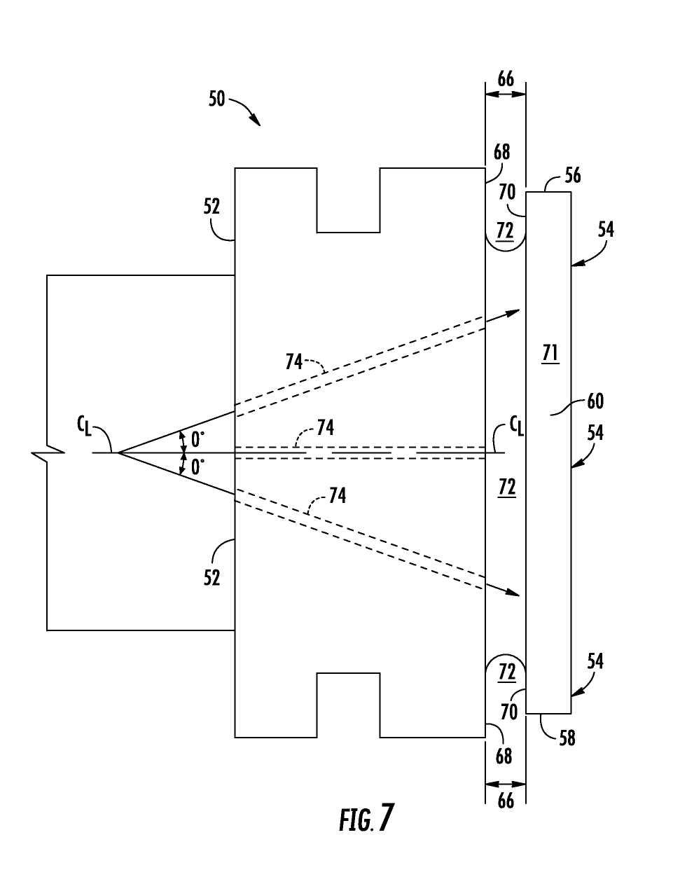

FIG. 4 provides a cross section of one of the pair of side portions 60 of the end frame 50 as taken at line A-A of FIG. 3. FIGS. 5 and 6 provide cross sections of the radially inner 58 and radially outer portions 56 of the end frame 50 as taken at line B-B as shown in FIG. 3. In particular embodiments, as shown in FIGS. 4-6, the end frame 50 may include a plurality of axially extending passages 62 that extend generally axially through at least a portion of the end frame 50 and through the terminal end 54 of the end frame 50. The plurality of axially extending passages 62 may be of any size, have any cross sectional shape, or be arranged in any manner so as to encourage flow through the plurality of axially extending passages 62. In this manner, at least a portion of the compressed working fluid 38 may flow from the combustor 14 plenum 34 and through the axially extending passages 62, thereby partially cooling at least a portion of the end frame 50.

In particular embodiments, as shown in FIGS. 4-6, at least a portion of the end frame 50 terminal end 54 may be coated with a heat resistant material 64. For example, but not limiting of, a thermal barrier coating. In particular embodiments, at least a portion of the plurality of axially extending passages 62 may extend through the end frame 50 terminal end 54 and through the heat resistant material 64. In this manner, the heat resistant material 64 may provide a thermal barrier between the terminal end 54 of the end frame 50 and the hot gas 42 flowing from the transition duct 26 into the turbine section 16. In addition, the compressed working fluid 38 may provide cooling to the end frame 50 and in particular, to the end frame 50 terminal end 54. As a result, the mechanical life of the end frame may be enhanced.

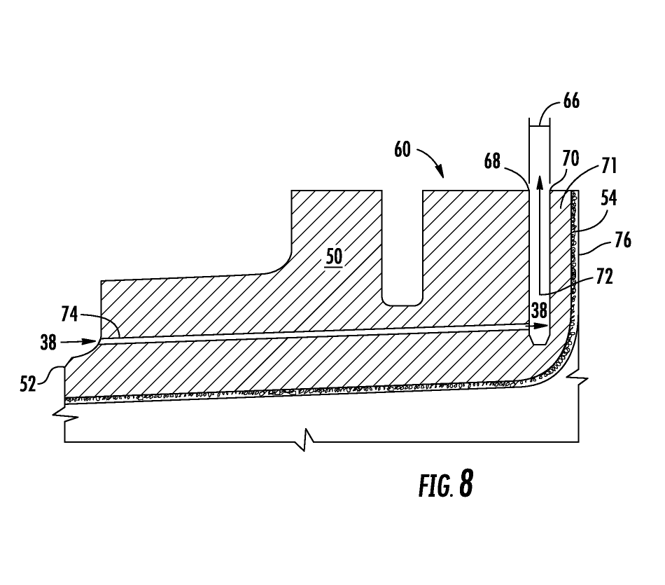

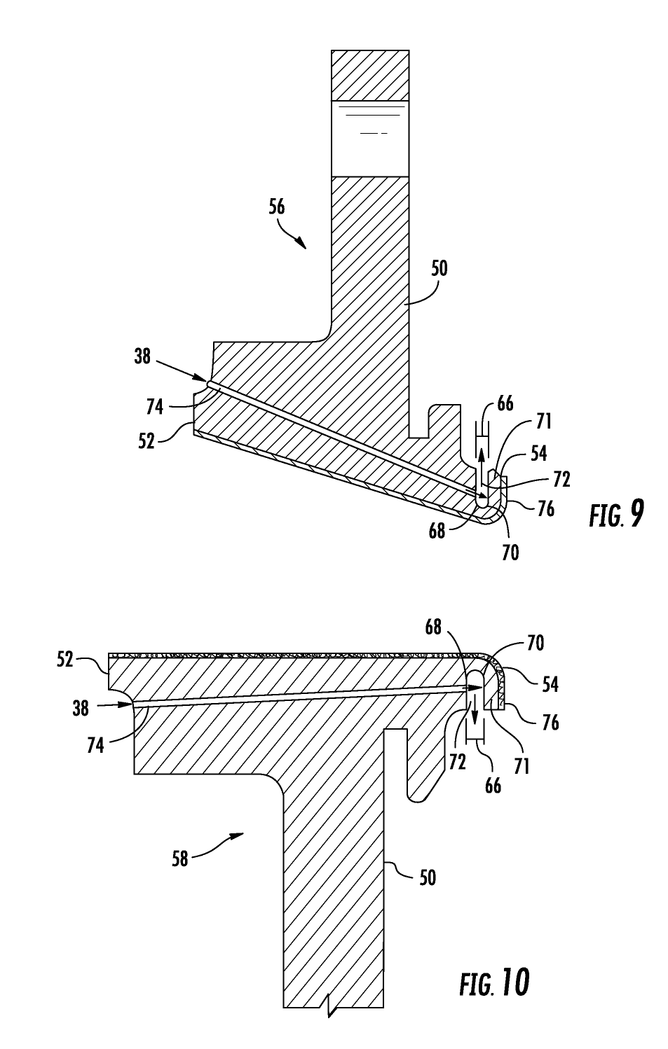

FIG. 7 provides a side view of the end frame 50 as shown in FIG. 3, FIG. 8 provides a cross section of one of the pair of side portions 60 of the end frame 50 as taken at line A-A in FIG. 3, FIG. 9 provides a cross section of the radially outer portion 56 of the end frame 50 as taken at line B-B as shown in FIG. 3, and FIG. 10 provides a cross section of the inner radial portion 58 of the end frame 50 as taken at line B-B as shown in FIG. 3. As shown in FIGS. 7-10, the various embodiments of the present invention may include means for cooling the end frame 50 terminal end 54. In particular embodiments, the structure for cooling the end frame 50 terminal end 54 may include a slot 66 in at least one of the end frame 50 radially outer portion 56 as shown in FIG. 9, the radially inner portion 58 as shown in FIG. 8, or the pair of side portions 60, as shown in FIG. 8. In particular embodiments, as shown FIG. 3 and in FIGS. 7-10 collectively, the slot 66 may extend generally uninterrupted circumferentially around the end frame 50. As shown in FIGS. 7-10 the slot 66 may be shaped so as to define an upstream surface 68 and a downstream surface 70 generally axially separated from the upstream surface 68. For example, but not limiting of, the slot 66 may be generally “U” shaped. In particular embodiments, as shown in FIGS. 7-10, the slot 66 may be disposed such that the slot downstream surface 70 is generally adjacent to the terminal end 54 of the end frame 50. In particular embodiments, as shown in FIGS. 7-10, the downstream surface 70 of the slot 66 may be generally continuous adjacent to the terminal end 54 of the end frame 50. In particular embodiments, as shown in FIGS. 7-10, the volume of the end frame between the slot 66 downstream surface 70 and the terminal end 54 of the end frame 50 may at least partially define a heat shield 71 that is integral to the end frame 50, thereby providing a protective barrier between the hot gas 42 flowing from the transition duct 26 into the turbine section.

As shown in FIGS. 7-10, the means for cooling the end frame 50 terminal end 54 may include a radial passage 72 that is at least partially defined between the upstream surface 68 and the downstream surface 70 of the slot 66. As shown, there may be multiple radial passages 72 defined by multiple slots 66 in the end frame 50. As shown in FIGS. 7 and 8, the radial passage 72 may be defined by the slot 66 in the pair of side portions 60 of the end frame 50. In addition or in the alternative, as shown in FIGS. 7, 10 and 11, the radial passage 72 may be defined in the outer radial portion 56 and/or the inner radial portion 58 of the end frame 50.

The means for cooling the end frame 50 terminal end 54 may further include a plurality of axially extending passages 74 that extend through at least a portion of the end frame 50 and that intersect with the slot 66. The plurality of axially extending passages 74 may be of any size, have any cross sectional shape, or be arranged in any manner so as to encourage flow through the plurality of axially extending passages 74. In particular embodiments, as shown in FIGS. 7-10, at least a portion of the axially extending passages 74 may extend from a point generally adjacent to the upstream end 52 of the end frame 50. In particular embodiments, as shown in FIG. 8, at least a portion of the plurality of axially extending passages 74 may intersect with the slot 66 in at least one of the pair of side portions 60 of the end frame 50. In addition or in the alternative, as shown in FIGS. 9 and 10 respectfully, at least a portion of the plurality of axially extending passages 74 may intersect with the slot 66 in at least one of the radially outer portion 56 or the radially inner portion 58 of the end frame 50.

In certain embodiments, as shown in FIGS. 7 and 8, at least one of the plurality of axially extending passages 74 may intersect generally perpendicular to the slot 66 upstream surface 80. In this manner, the compressed working fluid 38 flowing into the slot 76 may impinge on the downstream surface 80 of the slot 76, thereby providing impingement cooling to the downstream surface 70, thus cooling the end frame 50 terminal end 54. In addition or in the alternative, as shown in FIGS. 7, 9 and 10, at least a portion of the axially extending passages 74 may intersect with the slot 66 at an angle acute to the axial centerline of the end frame 50. In this manner, the compressed working fluid 38 flowing into the slot 66 may still at least partially impinge on the downstream surface 70 of the slot 66, thereby providing impingement cooling to the downstream surface 70, thus impingement cooling the terminal end 54 of the end frame 50. In addition, the compressed working fluid may flow across the slot 66 downstream surface 70, thereby providing convective and/or conductive cooling to the slot 66 downstream surface 70 and the terminal end 54 of the end frame 50.

In various embodiments, as shown in FIGS. 7-10, the compressed working fluid 38 flowing into the slot 66 may be channeled through the radial passage 72 and into the turbine section 16. As a result, the compressed working fluid 38 may provide cooling to the slot 66 upstream and downstream surfaces 68, 70, thereby cooling the end frame 50 and the terminal end 54. In addition, the compressed working fluid 38 may provide cooling to the first stage of stationary vanes 18 of the turbine section 16.

As shown in FIGS. 8-10, the means for cooling the end frame downstream end may also include a heat resistant material 76. In particular embodiments, as shown in FIGS. 8-10, the heat resistant material 76 may be disposed on at least a portion of the end frame 50 terminal end 54 adjacent to the slot 66 downstream surface 70. In various embodiments, as shown in FIGS. 8-10, the heat resistant material 76 may be applied in a continuous layer along the portion of the terminal end 54 of the end frame 50 that is adjacent to the slot 66 downstream surface 70. In this manner, the heat resistant material 76 may at least partially shield the terminal end 54 of the end frame 50 from the hot gas 42 flowing from the transition duct 26 into the turbine section 16. In this manner, the combination of the heat resistant material 76 and the impingement, convective and/or conductive cooling of the slot 66 downstream surface 70 provided by the compressed working fluid 38 flowing into the slot 66 may reduce the thermal stresses on the end frame 50 terminal end 54. As a result, the life of the end frame may be improved, thereby increasing the overall mechanical performance of the combustor 14.

In particular embodiments, the end frame terminal end may include a portion of the plurality of axially extending passages 62 extending through a portion of the terminal end in addition to the means for cooling the end frame terminal end. For example, the plurality of axially extending passages 62 may extend through the terminal end 54 of the end frame 50 adjacent to the radially inner and/or the radially outer portions of the end frame 50 as shown in FIGS. 5 and 6, while the pair of side portions 60 may include the slot 66 and the axially extending cooling passages 74 as shown in FIG. 8.

In alternate embodiments, the plurality of axially extending passages 62 may extend through the terminal end 54 of the end frame 50 adjacent to the pair of side portions 60 of the end frame 50 as shown in FIG. 4, while the radially outer portion 56 and the radially inner portion 58 may include the slot 66 and the axially extending cooling passages 74 as shown in FIGS. 9-10. In this manner, the thermal stresses may be selectively controlled by the placement of the slot 66 and axially extending cooling passages 74 relative to the placement of the axially extending passages 62 that extend through the end frame 50 terminal end 54.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A transition duct comprising;
a. an end frame having a radially outer portion, a radially inner portion opposed to the radially outer portion, a first side portion between the radially outer and inner portions, and a second side portion opposed to the first side portion between the radially outer and inner portions;
b. a slot in at least one of the radially outer portion, the radially inner portion, the first side portion, or the second side portion of the end frame;
c. a first plurality of axially extending passages through the end frame that intersect with the slot; and
d. a terminal end of the end frame, wherein the terminal end of the end frame is continuous adjacent to the slot.

2. The transition duct as in claim 1, wherein the slot extends through the end frame radially outer portion.

3. The transition duct as in claim 1, wherein the slot extends through the end frame radially inner portion.

4. The transition duct as in claim 1, wherein the slot comprises a first slot and further comprises a second slot, wherein the first slot extends through the end frame first side portion and the second slot extends through the end frame second side portion.

5. The transition duct as in claim 1, further comprising a second plurality of axially extending passages through the end frame, wherein the second plurality of axially extending passages pass through the end frame terminal end.

6. The transition duct as in claim 1, wherein at least some of the first axially extending passages are substantially perpendicular to the slot.

7. The transition duct as in claim 1, wherein at least some of the first axially extending passages intersect the slot at an acute angle relative to an axial centerline of the end frame.

8. The transition duct as in claim 1, further comprising a continuous layer of heat resistant material on the end frame terminal end adjacent to the slot.

9. A transition duct comprising;
a. an end frame having a radially outer portion, a radially inner portion opposed to the radially outer portion, a first side portion between the radially outer and inner portions, and a second side portion opposed to the first side portion between the radially outer and inner portions;
b. a radial passage in at least one of the radially outer portion, the radially inner portion, the first side portion, or the second side portion of the end frame;
c. a first plurality of axial passages through the end frame that terminate at the radial passage; and
d. a terminal end of the end frame downstream from the radial passage; and
e. a continuous layer of heat resistant material on the terminal end of the end frame adjacent to the radial passage.

10. The transition duct as in claim 9, wherein the radial passage extends through the end frame radially outer portion.

11. The transition duct as in claim 9, wherein the radial passage extends through the end frame radially inner portion.

12. The transition duct as in claim 9, wherein the radial passage comprises a first radial passage and further comprises a second radial passage, wherein the first radial passage extends through the end frame first side portion and the second radial passage extends through the end frame second side portion.

13. The transition duct as in claim 9, further comprising a second plurality of axially extending passages through the end frame, wherein the second plurality of axially extending passages pass through the end frame terminal end.

14. The transition duct as in claim 9, wherein at least some of the first axially extending passages are substantially perpendicular to the radial passage.

15. The transition duct as in claim 9, wherein at least some of the first axially extending passages intersect the radial passage at an acute angle.

16. A transition duct comprising;
a. an end frame having a radially outer portion, a radially inner portion opposed to the radially outer portion, a first side portion between the radially outer and inner portions, and a second side portion opposed to the first side portion between the radially outer and inner portions;
b. a terminal end of the end frame; and
c. means for cooling the end frame terminal end.

17. The transition duct as in claim 16, wherein the means for cooling the end frame terminal end comprises a slot in at least one of the radially outer portion, the radially inner portion, the first side portion, or the second side portion of the end frame.

18. The transition duct as in claim 16, wherein the means for cooling the end frame terminal end comprises a slot in at least one of the radially outer portion, the radially inner portion, the first side portion, or the second side portion of the end frame, and a first plurality of axially extending passages through the end frame that intersect with the slot.

19. The transition duct as in claim 16, wherein the means comprises a slot in at least one of the radially outer portion, the radially inner portion, the first side portion, or the second side portion of the end frame, and a continuous layer of heat resistant material on the terminal end of the end frame adjacent to the slot.

20. The transition duct as in claim 19, further comprising a plurality of axial passages that extend through the terminal end of the end frame adjacent to the continuous layer of heat resistant material.
